(19) United States
(12) Patent Application Publication
(10) Pub. No.: US 2013/0257293 A1
(43) Pub. Date: Oct. 3, 2013

(54) AUTOMATIC SYSTEM ENABLED DAYLIGHT SENSOR

(71) Applicants: Deeder Mohammad AURONGZEB, Mayfield Heights, OH (US); Timothy Florencki, Madison, WI (US)

(72) Inventors: Deeder Mohammad AURONGZEB, Mayfield Heights, OH (US); Timothy Florencki, Madison, WI (US)

(21) Appl. No.: 13/436,089

(22) Filed: Mar. 30, 2012

(51) Int. Cl. H05B 37/02

(52) U.S. Cl. 315/155

(57) ABSTRACT

A daylight sensor system includes a power circuit that converts high voltage AC to low voltage DC. The system includes a microcontroller, a motion detector, and a photodiode (PD) integrated circuit (IC). The PD IC provides an output to the microcontroller that is indicative of a lux reading in the vicinity of the system. In response, the microcontroller activates or deactivates a latching relay, which is connected to a line voltage and a load. The motion detector whether the daylight sensor system will be in an active mode of operation or an inactive mode. The microcontroller is programmed so that if the motion detector fails to detect motion for a certain amount of time, the microcontroller will go off line until the motion detector senses motion again.

### FIELD OF THE INVENTION

The field of the invention relates generally to lighting, and more particularly to a daylight sensor circuit and system.

### BACKGROUND OF THE INVENTION

Lighting systems in family homes and other buildings can waste energy by being left on when the lighted area is empty. By providing a central system, energy might be saved by remotely switching each of the light sources off at a particular time of day, for instance, thereby reducing the amount of light being wasted in locations that no longer require illumination. A direct current circuit that adjusts light output of a load based on the levels of ambient light in the atmosphere is known and includes a microcontroller and two integrated circuits (IC) to communicate the lux value of the environment to the microcontroller. However, a switch must be closed manually in order to provide power to the circuit. Moreover, the implementation and installation involved with typical lighting system upgrades, disadvantageously often require more than just component replacement and use of existing wiring. Upgrading to a centralized lighting control system may involve the tedious job of replacing components, tracing wiring, and rewiring to accommodate the new components. Thus, installation of such a control system may be complicated beyond the abilities of most homeowners, expensive, and disruptive to daily activities. These disadvantages currently preclude retrofitting most homes and other buildings in a way that would achieve energy savings by automatically turning off lights in unoccupied rooms.

### BRIEF DESCRIPTION OF THE INVENTION

Aspects and advantages of the invention are set forth below in the following description, or may be obvious from the description, or may be learned through practice of the invention.

An embodiment of the invention provides a daylight sensor system for a light fixture. The daylight sensor system can include a power circuit arranged to receive alternating current and to convert the received alternating current to direct current; a motion detector coupled to the power circuit; a photodiode integrated circuit (PD IC) coupled to the power circuit; and a microcontroller coupled with the PD IC and with the motion. The microcontroller has a first active state upon receiving a first output from the motion detector. The microcontroller has a second inactive state upon receiving a second output from the motion detector.

One embodiment of the daylight sensor system of the present invention includes a power circuit that converts high voltage (in an exemplary range of about 120 volts AC—about 270 volts) alternating current (AC) to low voltage (about 3.3 volts, plus or minus about 50%) direct current (DC). The power circuit desirably can include a transformer and a bridge rectifier. The low voltage DC output from the power circuit DC is used to power a microcontroller, a passive infrared (PIR) motion detection circuit, and a photodiode (PD) integrated circuit (IC). The PD IC and the microcontroller can communicate using the inter-integrated circuit communications (I2C) protocol, or other suitable wireless communications protocol.

The microcontroller can receive an output from the PD IC that represents a lux reading in a vicinity of the daylight sensor system. Using this information, the microcontroller will activate or deactivate a latching relay, that is connected to a line voltage and a load. The load can be a lamp and/or a lamp ballast. These actions will determine whether power is provided to the load.

The motion detector is operative to act as a “system enable.” This means that the motion detector determines whether the daylight sensor system will be in an active mode of operation or an inactive mode of operation. Movement in the vicinity of the daylight sensor system will determine whether the output of the motion detector, either ‘high’ or ‘low’. In one embodiment, no movement in the vicinity of the daylight sensor system can render a first output of the motion detector ‘low”. Movement in the vicinity of the daylight sensor system can render a second output of the motion detector “high”. In such an embodiment, it could be required that the first output of the motion detector be received by the microcontroller in order for any other function to take place. The microcontroller can be programmed so that if the second output received from the motion detector continues for a predetermined time, the microcontroller will go off line, and/or keep in the inactive state, until it receives output from the motion detector that becomes ‘low’ again.

Another embodiment of the present invention includes a method for automatically controlling an electrical load to conserve energy. The method desirably includes receiving inputs from a motion detection circuit and a photodiode (PD) integrated circuit (IC) at a programmable controller. The method desirably includes using the motion detection circuit to act as a “system enable,” and in one embodiment the output of the motion detection circuit will swing ‘low’ when detecting movement in the vicinity of the motion detection circuit and will swing ‘high’ when failing to detect movement in the vicinity of the motion detection circuit. In such an embodiment, the output of the motion detection circuit must be ‘low’ in order for any other function to take place. In such an embodiment, the microcontroller is programmed so that if the output of the motion detection circuit is ‘high’ for a predetermined amount of time, then the microcontroller will go off line until the motion detection circuit output becomes ‘low’ again. The method desirably includes using the PD IC to send to the microcontroller an output. This output from the PD IC can represent a lux reading in the vicinity of the PD IC. The method desirably includes using this output from the PD IC to determine whether the microcontroller will activate or deactivate a latching relay, which may be connected directly to a line voltage and a load. The method desirably includes using these actions to determine whether AC power is provided to the load.

Those of ordinary skill in the art will better appreciate the features and aspects of such embodiments, and others, upon review of the specification.

### BRIEF DESCRIPTION OF THE DRAWINGS

A full and enabling disclosure of the present invention, including the best mode thereof to one skilled in the art, is set forth more particularly in the remainder of the specification, including reference to the accompanying figures, in which:

FIG. 1 is an elevated perspective view of an exemplary embodiment of a daylight sensor system;

FIG. 2 schematically represents a block diagram of an embodiment of a daylight sensor circuit and system of the present invention;

FIG. 3 schematically represents a flow diagram of an embodiment of a computer program for the programmable microcomputer of the daylight sensor system of the present invention;

FIGS. 4, 5, 6, and 7 schematically represent block diagrams of an embodiment of circuitry required to control the relay of the daylight sensor system of the present invention;

FIG. 8 schematically represents a block diagram of an exemplary embodiment of a PIR circuit according to an embodiment of a daylight sensor circuit and system of the present invention; and

FIG. 9 schematically represents a block diagram of an exemplary embodiment of a method for automatically controlling an electrical load to conserve energy.

### DETAILED DESCRIPTION OF THE INVENTION

Reference will now be made in detail to present embodiments of the invention, one or more examples of which are illustrated in the accompanying drawings. The detailed description uses numerical and letter designations to refer to features in the drawings. Like or similar designations in the drawings and description have been used to refer to like or similar parts of the invention.

Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents.

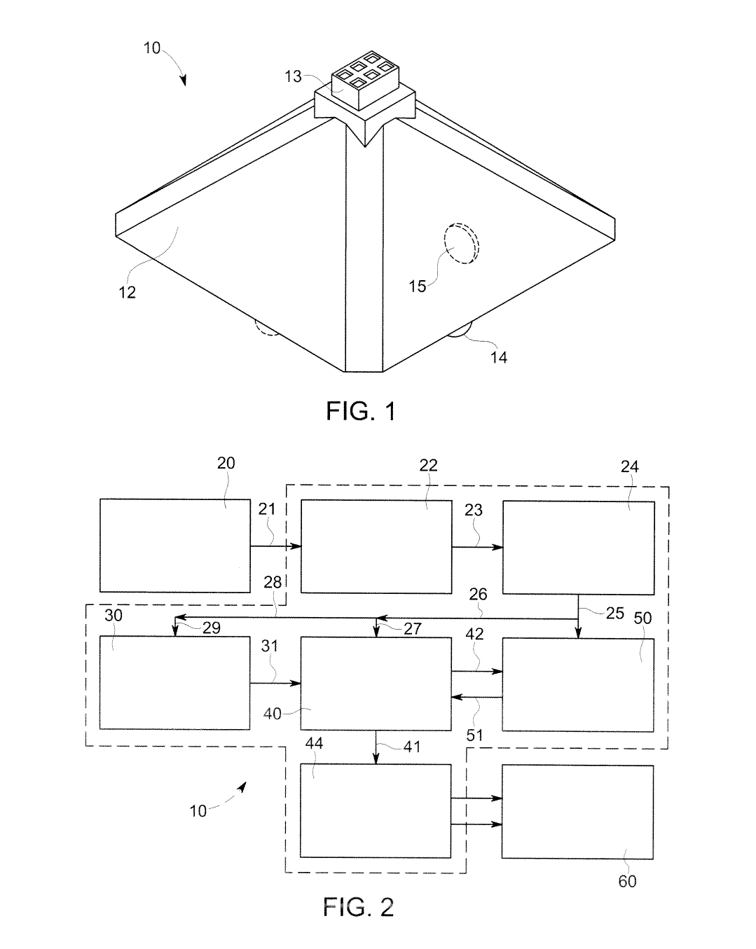

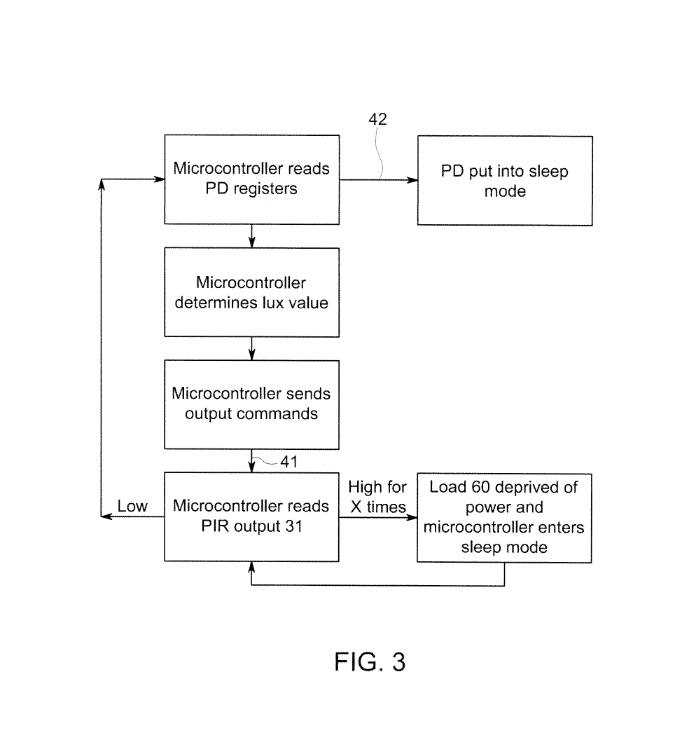

FIG. 1 is an elevated perspective view of an exemplary embodiment of a daylight sensor system 10. FIG. 2 schematically represents a block diagram of an embodiment of a daylight sensor circuit that can be used with the daylight sensor system 10 of FIG. 1.

Referring to FIGS. 1 and 2, an embodiment of the daylight sensor system 10 is shown in a perspective view. The daylight sensor system 10 can include a socket 13, a housing 12, at least one opening 15 in the housing, and a lens 14 that is coupled with a motion detection circuit. A light sensor can be positioned within the housing 12 and proximate the at least one opening 15 so that ambient light entering the opening 15 reaches the light sensor. In one embodiment, the light sensor is a photodiode. The lens 14 can be a Fresnel lens that expands an infrared, or other type, of motion detection volume. The socket 13 can be a male or female socket. As further explained below with reference to FIG. 2, the daylight sensor system 10 may further include an AC-DC converter 22 that is coupled with the socket 13.

To provide energy savings, the daylight sensor system 10 is preferably integrated into the electrical service for the load (typically a light fixture). One simple way of achieving this result that is within the capability of most users is by replacing the light controller in a room with a plug or socket that mates with a corresponding socket 13 of the daylight sensor system 10. The daylight sensor system 10 can be mounted on a ceiling or on a wall.

Referring to FIG. 2, an embodiment of the daylight sensor system 10 that is contained within the housing 12 (FIG. 1) is shown in block diagram form and schematically indicated by the dashed outline. The power supply 20, such as that commonly found in homes, to which the daylight sensor system 10 can be electrically connected by the socket 13 (FIG. 1). The power supply 20 is preferably 120 volt AC service, but can be other AC voltages, such as 277 volt AC. Arrow 21 represents the AC power output that flows to the socket 13 of the daylight sensor system 10.

An AC-DC converter 22 functions to rectify the AC output power 21 provided by the power supply 20 and convert the AC output power 21 into a direct current (DC) output 23 at lower low voltage (e.g., 3.3 volts DC). As schematically shown in FIG. 2, the low voltage DC output 23 from the AC-to-DC converter 22 energizes the DC power supply 24 that is used to power various components of the daylight sensor system 10.

Motion detector 30 is coupled with the DC power supply 24. A microcontroller 40 is coupled with the DC power supply 24 and the motion detector 30. One example of a suitable microcontroller 40 that operates on extremely low power is available from Microchip Technology, Inc. of Chandler, Ariz. as model PIC18F4420. This microcontroller 40 is part of the XLP (Extremely Low Power) family of microcontrollers. A photodiode integrated circuit (PD IC) 50 is coupled with the DC power supply 24 and the microcontroller 40. A suitable photodiode integrated circuit 50 is available from Intersil of Milpitas, Calif. as model ISL29020. As schematically shown by the arrows designated 25, 26, 27, 28 and 29 in FIG. 2, the low voltage DC output is used to power the motion detector 30, the microcontroller 40 and the photodiode integrated circuit 50.

Motion detector 30 can include a passive infrared (PIR) circuit. The PIR circuit can include a pyroelectric material. In operation, when the motion detector 30 detects motion in the vicinity of the daylight sensor system 10 it outputs a signal to the microcontroller 40 indicating that the room (or other area in the vicinity of the daylight sensor system 10) containing the load 60 (e.g., a light fixture) that is to be controlled by the daylight sensor system 10 is occupied, and thus the daylight sensor system 10 is configured in its active mode. Conversely, if the motion detector 30 fails to detect any motion for a predetermined period of time, the microcontroller 40 will place the entire daylight sensor system 10 into a sleep (inactive) mode, thus conserving energy.

As schematically shown by the arrow designated 31 in FIG. 2, the motion detector 30 can generate a low output 31 commensurate with the detection of motion or a high output 31 in the absence of any motion being detected. Thus, the output 31 of the motion detection circuitry 30 will swing low or high based on movement in the room (or other area) that contains the load 60, which is controlled by the daylight sensor system 10, or respectively an absence of any movement. The output 31 of the motion detection circuitry 30 is provided to the microcontroller 40, which is programmed to configure the daylight sensor system 10 in either the active mode or the passive (inactive) mode, depending on the output 31 (low or high) of the motion detection circuitry 30 and the duration of that output 31 over a preset number of consecutive sampling sequences by the microcontroller 40. In one embodiment, the output 31 of the motion detector 30 must be ‘low’ in order for the daylight sensor system 10 to be configured in the active mode that permits any other load-controlling function by the daylight sensor system 10 to take place. In this desirable embodiment, if the output 31 of the motion detection circuitry 30 is ‘high’ for a predetermined amount of time, the microcontroller 40 goes off-line until the output 31 of the motion detection circuitry 30 becomes ‘low’ again. In this way, the output 31 of the motion detection circuitry 30 determines whether the daylight sensor system 10 is configured in either the active mode or the passive mode and conserves energy by becoming inactive when the room is empty.

The PD IC 50 and the microcontroller 40 can communicate via I2C protocol, and such communications are schematically represented by the arrows designated 51 and 42 in FIG. 2. The I2C protocol provides for an easy and reliable way to obtain the actual lux reading, as no calibration is needed. As arrow 42 illustrates, the microcontroller 40 samples the output of the photodiode IC 50. As arrow 51 illustrates, the photodiode IC 50 detects light in the vicinity of the daylight sensor system 10 and generates output data commensurate with the light detected. The microcontroller 40 interprets the output data received from the photodiode IC 50 and generates necessary output commands, which are represented by the arrow 41.

These output commands 41 can vary depending on the application. For example, as schematically shown in FIG. 2, the microcontroller 40 can activate or deactivate one or more relays 44 that are connected to the load 60 and thereby control the load 60. In one embodiment, the load 60 can be a lighting fixture that includes a dimmable linear fluorescent lamp (LFL) ballast and up to four linear fluorescent lamps. The lighting fixture that is the load 60 can comprise a general area lighting source, such as a fluorescent lamp, for example, which may be implemented in a home or in a commercial or industrial building. Each fluorescent lamp generally includes a light producing or “on state,” and an “off state” wherein no light is produced by the fluorescent lamp. As can be appreciated, the on state of a lamp also may include various levels of illumination, thus making the lamp “dimmable.” Fluorescent lamps typically use a ballast to maintain a stable discharge current in the lamp, and the ballast provides a high starting voltage to ignite the lamp followed by a current-limiting mode of operation. Accordingly, the output commands 41 of the microcontroller 40 can take the form of a pulse width modulated (PWM) signal that can directly interface to LFL ballasts or LED drivers to provide dimming capability on the load 60.

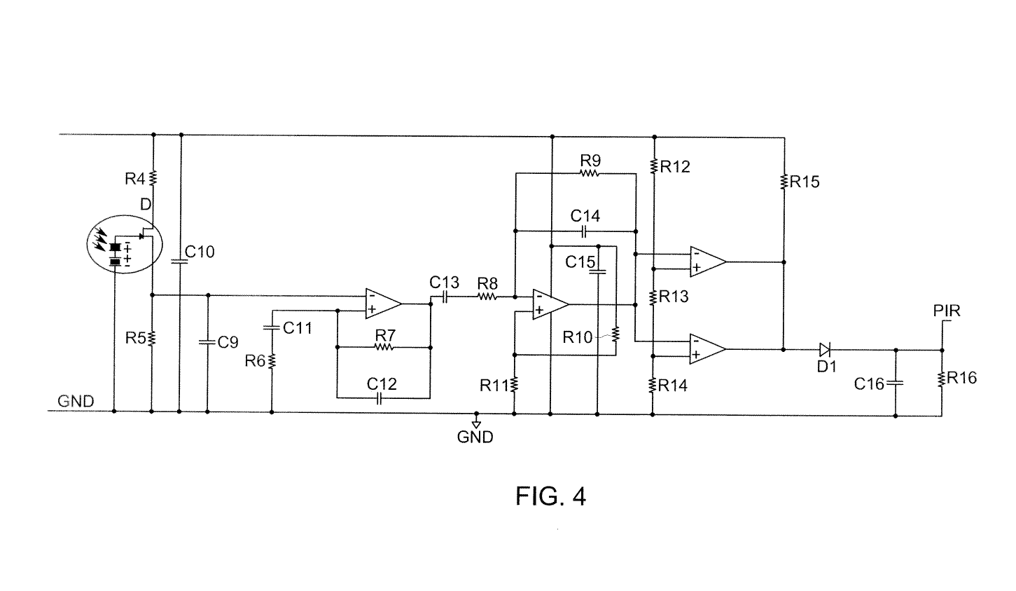

FIG. 3 is a flow diagram illustrating an embodiment of a computer program presented in the Appendix, which can be read and executed by the microcontroller 40. Referring to FIGS. 1, 2, and 3, the microcontroller 40 acts as the master in the I2C communications with the photodiode integrated circuit (PD IC) 50 being the slave. If the daylight sensor system 10 is in the active mode, then the microcontroller 40 will read the registers of the PD IC 50. The PD IC 50 can output sixteen bits of information that are directly proportional to the measured lux value of the atmosphere in the vicinity of the daylight sensor system 10. After the microcontroller 40 has read the registers of the PD IC 50, it puts the PD IC 50 into the sleep (inactive) mode until the next time that a lux measurement is needed. This way of programming the microcontroller 40 provides an energy conservation feature, which in one exemplary embodiment reduces the current consumption by the PD IC 50 from 65 μA when active to 0.3 μA when in sleep mode.

Referring again to FIG. 3, after reading the registers of the PD IC 50, the microcontroller 40 can convert the sixteen bit information into the lux value and generate the desired output commands 41. Referring to FIGS. 1, 2 and 3, after the desired output commands 41 are generated, the PIR output 31 is checked. If the PIR circuit does not detect motion for a set period of time, then the load 60 will be deactivated and the daylight sensor system 10 will enter sleep mode and stop consuming power until motion is detected by the motion detection circuitry 30.

The exemplary code presented in the Appendix is set to respond almost instantaneously to changes in light value and occupancy of the vicinity of the daylight sensor system 10. This was done so that the performance of the daylight sensor system 10 could be easily evaluated. In other embodiments, the code presented in the Appendix can modified and/or configured to build in a delay so that the daylight sensor system 10 does not respond instantaneously to changes in the environment of the vicinity of the daylight sensor system 10. There desirably will be some timeout period that allows the daylight sensor system 10 to ignore transients in the environment of the vicinity of the daylight sensor system 10.

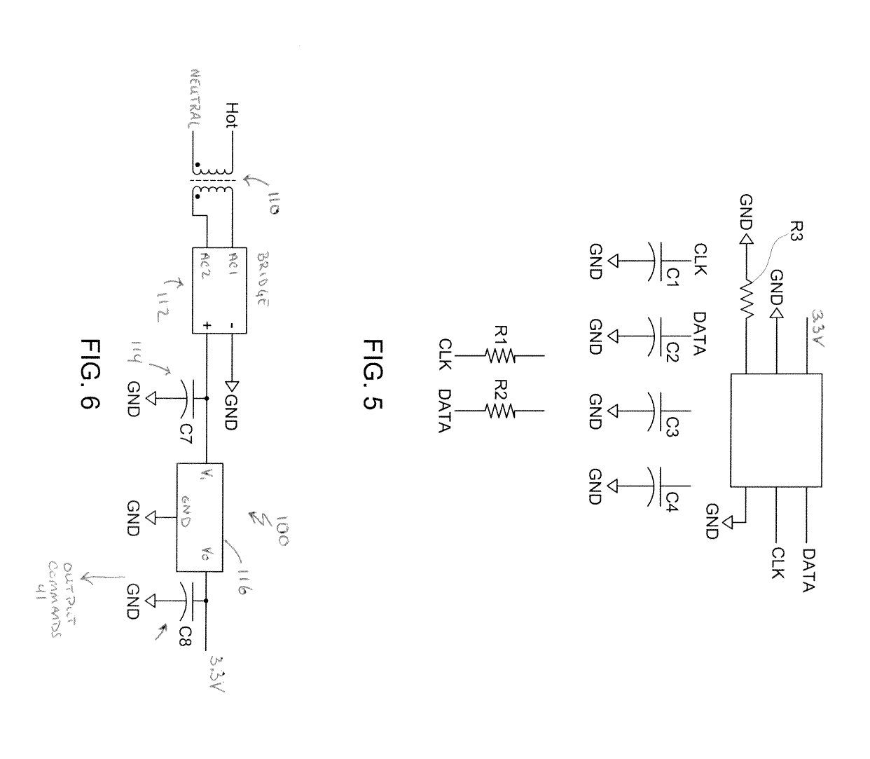

An embodiment of microcontroller circuit assembly required to control the relay 44, which is schematically depicted in FIG. 2, is shown in the schematic diagrams presented in FIGS. 4, 5, 6 and 7. As shown in FIG. 4, a power control circuit 100 desirably is used to step down the AC input (120 VAC-277 VAC) 110. It is possible to step down the voltage up to 450V. The reduced AC input is fed into a full bridge rectifier 112. The output of the full bridge rectifier is smoothed with capacitor(s) 114 and fed into a voltage regulator 116. The approximately three volts DC output from the voltage regulator 116 may used to power all of the circuitry except an operational amplifier and a relay 44, each of which may use about ten volts DC. A low pass filter, (ω_{c}=1 kHz, which is the frequency of the PWM signal) is used to smooth the PWM output 41 before it is fed into a non-inverting amplifier with a gain of 5 or greater. An exemplary component list for the schematic circuit diagrams presented in FIGS. 4, 5, 6 and 7 is presented in Table I below.

TABLE I

| Reference | Value | Reference | Value |
|---|---|---|---|
| R1 | 1M | C1 | 1 uF |
| R2 | 1M | C2 | 22 nF |
| R3 | 22k | C3 | 47 uF |
| R4 | 1M | C4 | 22 uF |
| R5 | 22k | C5 | 22 nF |
| R6 | 1M | C6 | 22 uF |
| R7 | 1M | C7 | 1 uF |
| R8 | 1M | C8 | 22 nF |
| R9 | 1M | C9 | .68 uF |
| R10 | 3.3M | C10 | 3.3 uF |
| R11 | 1M | C11 | .1 uF |
| R12 | 1M | C12 | 1 uF |
| R13 | 500k | C13 | 47 uF |
| R14 | 10k | C14 | 1 uF |
| R15 | 10k | C15 | .01 uF |
| R16 | 240 | C16 | 1 uF |
| M1/M2 | FET | RELAY | Latching |

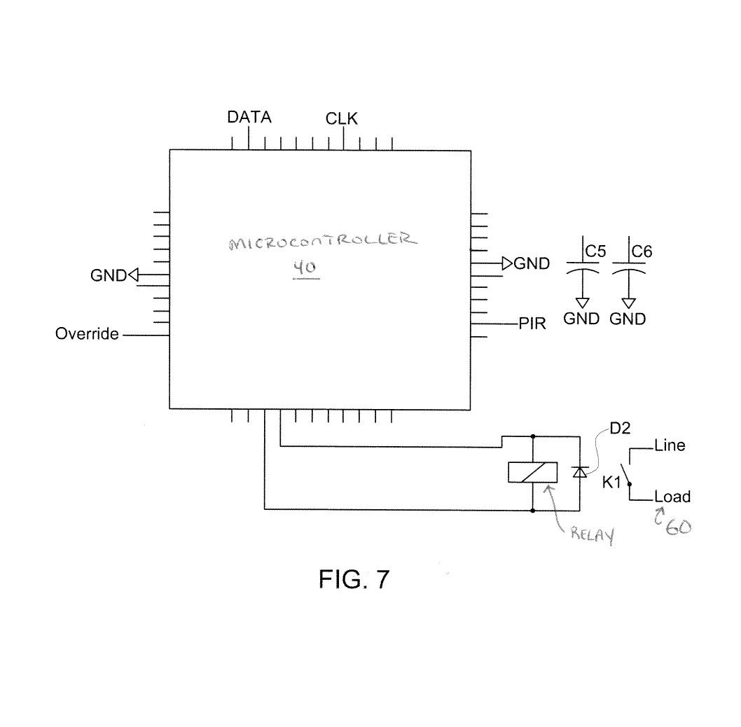

FIG. 8 illustrates an exemplary PIR circuit of the motion detector 30. In operation, infrared energy passes through the lens 14 in the housing 12 (FIG. 1) of the daylight sensor system 10 and stimulates a PIR sensor of an embodiment of the motion detection circuitry 30 (FIG. 2) so as to generate a very low amplitude sinusoidal-like signal when motion is detected. The strength of this signal depends on the direction of the motion that is detected. The motion detection signal generated by the PIR sensor is passed through a two stage amplifier and filter. The amplifier increases the amplitude of the signal, and the filter is used to filter out unwanted noise. In one embodiment, the center frequency of the filter desirably is located at 1 Hz, and the passband can range from about 0.1 Hz to about 10 Hz. These values were obtained by conducting tests that determined a person's average walking speed. The output of this stage is fed into a window comparator. The output of the window comparator will float high if the amplitude of the signal is neither higher than the upper bound nor smaller than the lower bound. The output will be driven low if the amplitude of the signal is either higher than the upper bound or smaller than the lower bound. Again, it is important to note that the sense of the signal from the PIR sensor depends on the direction of the detected motion. Also, the window comparator provides another means to filter out unwanted noise.

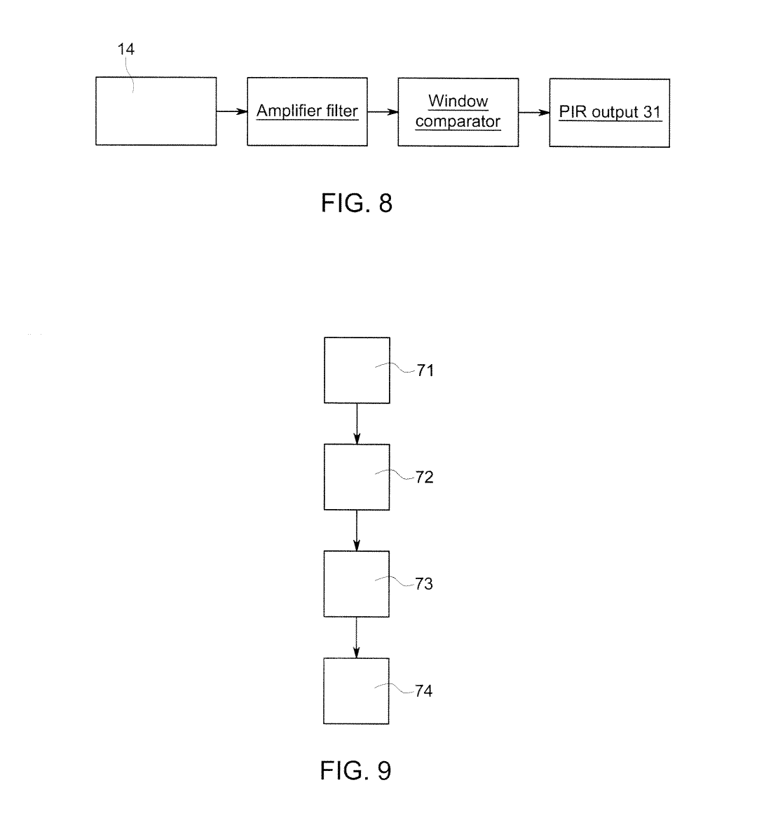

FIG. 9 is a flow diagram that illustrates an exemplary method for automatically controlling an electrical load to conserve energy. Unless otherwise noted, the steps of FIG. 9 can be performed in any suitable order and/or in parallel.

The method can include receiving 71 inputs from a motion detector and a photodiode (PD) integrated circuit (IC) at a microcontroller. The method can further include determining 72, using the output of the motion detector, whether to place a daylight sensor system in an active mode or in an inactive mode. In one embodiment, the output of the motion detector will swing ‘low’ when detecting movement in the vicinity of the motion detector and will swing ‘high’ when failing to detect detecting movement in the vicinity of the motion detection circuit. In this exemplary embodiment, the output of the motion detection circuit must be ‘low’ in order for any other function to take place. In this exemplary embodiment, the microcontroller is programmed so that if the output of the motion detection circuit is ‘high’ for a certain amount of time, then it will go off line until the motion detector output becomes ‘low’ again. In this way the motion detector functions as a “system enable.”

Referring to FIGS. 2 and 9, the method can also include actions that will determine whether power is provided to the load 60. For example, the method can further include receiving 73 at the microcontroller a digital value output from the PD IC that represents a lux reading in the vicinity of the PD IC.

The method can further include determining 74, using this lux reading, whether to activate or deactivate a latching relay that is coupled with the microcontroller and the load 60. The load 60 can be a lighting fixture, a fluorescent lamp, or a dimmable LFL ballast.

Embodiments of the invention described and shown herein afford one or more advantages and/or technical effects over prior systems. Illustratively, such advantages and/or technical effects can include one or more of the following:

Powered by line voltage—the consumer does not have to purchase step-down transformer;

Output connected directly to line voltage—consumer does not have to purchase an external relay;

Not active when room is empty—consumer does not have to activate an external switch;

Removal of unnecessary functions—no interface to a building automation system (BAS) is needed; and

One integrated circuit (IC) communicates directly with the microcontroller—this eliminates need for two integrated circuits.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other and examples are intended to be within the scope of the claims if they include structural elements that do not differ from the literal language of the claims, or if they include equivalent structural elements with insubstantial differences from the literal languages of the claims.

What is claimed is:

1. A daylight sensor system for a light fixture, the daylight sensor system comprising:
a power circuit arranged to receive alternating current and to convert the received alternating current to direct current;
a motion detector coupled to the power circuit;
a photodiode integrated circuit (PD IC) coupled to the power circuit; and
a microcontroller coupled with the PD IC and with the motion detector, the microcontroller having a first active state upon receiving a first output from the motion detector, and the microcontroller having a second inactive state upon receiving a second output from the motion detector.

2. The daylight sensor system of claim 1,
wherein the first output from the motion detector is low when the motion detector senses movement in the vicinity of the daylight sensor system, and
wherein the second output from the motion detector is high when the motion detector senses no movement in a vicinity of the daylight sensor system.

3. The daylight sensor of claim 1, wherein, if the second output from the motion detector continues for a predetermined time, the microcontroller will keep the second inactive state until the microcontroller receives the first output from the motion detector.

4. A daylight sensor system for a light fixture, the daylight sensor system comprising:
a power circuit arranged to receive alternating current and to convert the received alternating current to direct current;
a motion detector coupled to the power circuit; and
a photodiode integrated circuit (PD IC) coupled to the power circuit; and
a microcontroller coupled with the PD IC and with the motion detector; and
a relay coupled with the microcontroller, wherein the microcontroller is configured to activate the relay upon receipt of an output from the PD IC that is indicative of a lux reading.

5. The daylight sensor system of claim 3, wherein the microcontroller is further configured to deactivate the relay upon receipt of an output from the PD IC that is indicative of another lux reading.

6. The daylight sensor system of claim 1, wherein the lighting fixture is a lamp.

7. The daylight sensor system of claim 1, wherein the lighting fixture is a lamp ballast.

8. A method, comprising at a microcontroller of a lighting fixture:
receiving outputs from a motion detector and a photodiode (PD) integrated circuit (IC);
determining, using the received outputs from the motion detector, whether the microcontroller is in an active mode;
receiving from the PD IC an output representing a lux reading in the vicinity of the PD IC; and
determining based on the output received from the PD IC whether the microcontroller will activate or deactivate a relay.

9. The daylight sensor system of claim 1, wherein the lighting fixture is a lamp.

10. The daylight sensor system of claim 1, wherein the lighting fixture is a lamp ballast.
